(19) United States
(12) Patent Application Publication
(10) Pub. No.: US 2025/0300758 A1
(43) Pub. Date: Sep. 25, 2025

(54) TERMINAL, BASE STATION AND RADIO COMMUNICATION METHOD

(71) Applicant: NTT DOCOMO, INC., Tokyo (JP)

(72) Inventors: Haruhi ECHIGO, Tokyo (JP); Daisuke KURITA, Tokyo (JP); Hiroki HARADA, Tokyo (JP)

(73) Assignee: NTT DOCOMO, INC., Tokyo (JP)

(21) Appl. No.: 18/717,444

(22) PCT Filed: Dec. 10, 2021
(86) PCT No.: PCT/JP2021/045695

§ 371 Date: Oct. 21, 2024

(51) Int. Cl. H04L 1/00; H04L 27/26; H04W 72/1263; H04W 74/0833

(52) U.S. Cl. CPC H04L 1/0003; H04L 27/2607; H04W 72/1263; H04W 74/0833

(57) ABSTRACT

According to one aspect of the present disclosure, there is provided a terminal including a control unit that determines a Modulation and Coding Scheme (MCS) and a number of repetitions from an MCS field in an uplink grant for repetitive transmissions of an uplink data channel for retransmission in a random access procedure, and a transmission unit that repeatedly transmits the uplink data channel for retransmission in the random access procedure in accordance with the MCS and the number of repetitions.

### TECHNICAL FIELD

The present disclosure relates to a terminal, a base station and a radio communication method.

### BACKGROUND ART

The 3rd generation Partnership Project (3GPP) standardizes the fifth generation mobile communication system (which may be also referred to as 5G, New Radio (NR) or Next Generation (NG)), and is further promoting standardization of the next generation such as Beyond 5G, 5G Evolution or 6G.

For example, in 3GPP Release-17, Work Items regarding Coverage Enhancement (CE) in the NR are agreed (Non-Patent Document 1).

Specifically, standardization of PUSCH repetition of a PUSCH scheduled by an RAR UL grant or a PUSCH scheduled by DCI with a CRC scrambled by a TC-RNTI is being discussed. Note that the RAR is an abbreviation of a Random Access Response. The DCI is an abbreviation of Downlink Control Information. The CRC is an abbreviation of a Cyclic Redundancy Check. The TC-RNTI is an abbreviation of a Temporary Cell-Radio Network Temporary Identifier. The PUSCH is an abbreviation of a Physical Uplink Shared Channel.

### PRIOR ART DOCUMENT

### Non-Patent Document

Non-Patent Document 1: “New WID on NR coverage enhancements”, RP-202928, 3GPP TSG RAN meeting #90e, 3GPP, December 2020.

### SUMMARY OF INVENTION

There is still room for consideration on implementation of repetitive transmissions of an uplink channel in a random access procedure.

According to one aspect of the present disclosure, there is provided a terminal, comprising: a control unit that determines a Modulation and Coding Scheme (MCS) and a number of repetitions from an MCS field in an uplink grant for repetitive transmissions of an uplink data channel for retransmission in a random access procedure; and a transmission unit that repeatedly transmits the uplink data channel for retransmission in the random access procedure in accordance with the MCS and the number of repetitions.

### BRIEF DESCRIPTION OF DRAWINGS

FIG. 1 is a schematic diagram for illustrating a radio communication system according to one embodiment of the present disclosure;

FIG. 2 is a diagram for illustrating one exemplary frequency range for use in the radio communication system according to one embodiment of the present disclosure;

FIG. 3 is a diagram for illustrating an exemplary arrangement of a radio frame, a subframe and a slot for use in the radio communication system according to one embodiment of the present disclosure;

FIG. 4 is a sequence diagram for illustrating a Contention Based Random Access procedure according to one embodiment of the present disclosure;

FIG. 5 is a sequence diagram for illustrating a Contention Free Random Access procedure according to one embodiment of the present disclosure;

FIG. 6 is a diagram for illustrating mapping information according to one embodiment of the present disclosure;

FIG. 7 is a diagram for illustrating mapping information according to one embodiment of the present disclosure;

FIG. 8 is a diagram for illustrating mapping information according to one embodiment of the present disclosure;

FIG. 9 is a diagram for illustrating mapping information according to one embodiment of the present disclosure;

FIG. 10 is a diagram for illustrating mapping information according to one embodiment of the present disclosure;

FIG. 11 is a block diagram for illustrating a functional arrangement of a base station (gNB) according to one embodiment of the present disclosure;

FIG. 12 is a block diagram for illustrating a functional arrangement of a terminal (UE) according to one embodiment of the present disclosure;

FIG. 13 is a block diagram for illustrating a hardware arrangement of a base station and a terminal according to one embodiment of the present disclosure; and

FIG. 14 is a block diagram for illustrating a hardware arrangement of a vehicle according to one embodiment of the present disclosure.

### DESCRIPTION OF EMBODIMENTS

Embodiments of the present disclosure are described below with reference to the drawings.

### Radio Communication System

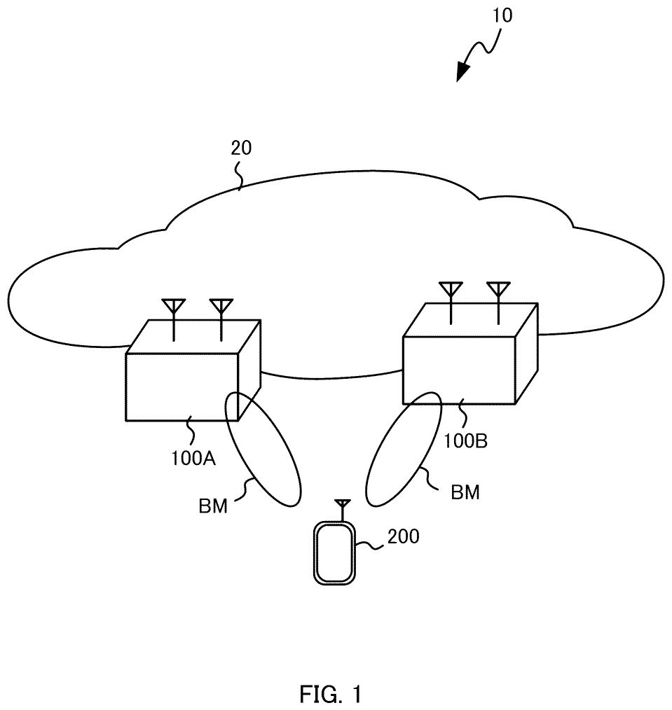

FIG. 1 is a diagram for illustrating one exemplary radio communication system 10 according to one embodiment. The radio communication system 10 is a radio communication system conforming to 5G New Radio (NR) and includes a Next Generation-Radio Access Network 20 (NG-RAN 20 hereinafter) and a terminal 200 (UE 200 hereinafter).

Note that the radio communication system 10 may be a radio communication system conforming to schemes referred to as Beyond 5G, 5G Evolution or 6G.

The NG-RAN 20 includes a base station 100A (gNB 100A hereinafter) and a base station 100B (gNB 100B hereinafter). Note that if distinction of the gNB 100A, the gNB 100B and others is unnecessary, they may be collectively referred to as a gNB 100. Also, the number of gNBs and UEs is not limited to the example as illustrated in FIG. 1.

In fact, the NG-RAN 20 may include multiple NG-RAN nodes, specifically, gNBs (or ng-eNBs), and may be accessed to a core network conforming to 5G (5GC) (not illustrated). Note that the NG-RAN 20 and the 5GC may be simply represented as a “network”.

The gNB 100A and the gNB 100B are base stations conforming to 5G and perform radio communication with the UE 200 in accordance with 5G. The gNB 100A, the gNB 100B and the UE 200 may support Multiple-Input Multiple-Output (MIMO) where radio signals transmitted from multiple antenna elements are controlled to generate highly directional beams BMs, Carrier Aggregation (CA) using a bundle of component carriers (CCs), Dual Connectivity (DC) where communications between a UE and two NG-RAN nodes are conducted, and others.

Also, the radio communication system 10 supports multiple frequency ranges (FRs).

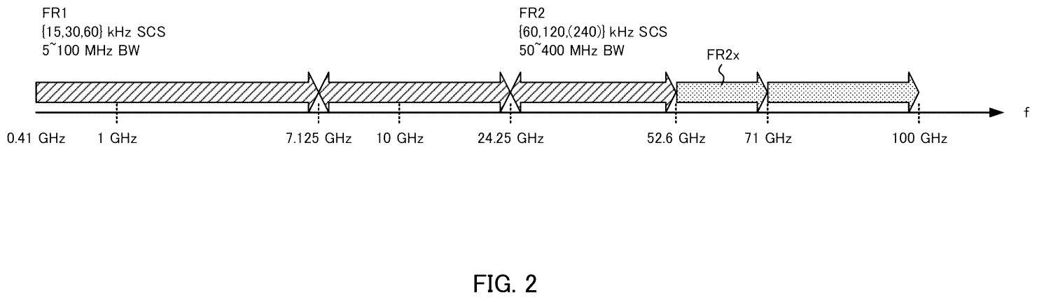

FIG. 2 is a diagram for illustrating exemplary frequency ranges for use in the radio communication system 10. As illustrated in FIG. 2, the radio communication system 10 supports an FR 1 and an FR 2. Frequency bands of the respective FRs may be as follows, for example.
FR 1: 410 MHz to 7.125 GHz
FR 2: 24.25 GHz to 52.6 GHz

In FR 1, Sub-Carrier Spacing (SCS) of 15 kHz, 30 kHz or 60 kHz may be used, and a bandwidth (BW) of 5 to 100 MHz may be used. FR 2 is a higher frequency than FR 1. In FR 2, the SCS of 60 kHz or 120 kHz (which may include 240 kHz) may be used, and the bandwidth (BW) of 50 to 400 MHz may be used.

Note that the Sub-Carrier Spacing (SCS) may be interpreted as numerology. The numerology is defined in 3GPP TS 38.300 and corresponds to one subcarrier interval in the frequency domain.

Furthermore, the radio communication system 10 may support a higher frequency band than that of the FR 2. Specifically, the radio communication system 10 may support a frequency band higher than 52.6 GHz and lower than 114.25 GHz. Such a high frequency band may be referred to as a “FR 2x” for convenience. If a band higher than 52.6 GHz is used, Cyclic Prefix-Orthogonal Frequency Division Multiplexing (CP-OFDM)/Discrete Fourier Transform-Spread-Orthogonal Frequency Division Multiplexing (DFT-D-OFDM) having a greater SCS may be applied.

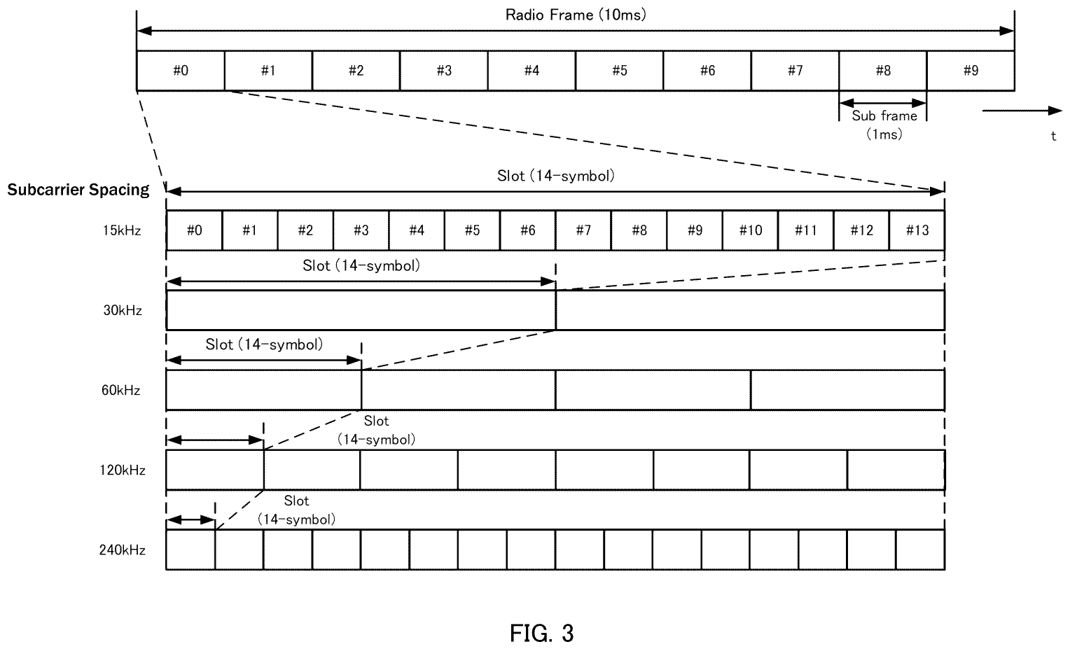

FIG. 3 is a diagram for illustrating an exemplary arrangement of a radio frame, a subframe and a slot for use in the radio communication system 10. As illustrated in FIG. 3, one slot is composed of 14 symbols, and the greater (wider) the SCS is, the shorter the symbol period (and slot period) is. The SCS is not limited to an interval (frequency) as illustrated in FIG. 3. For example, 480 kHz, 960 kHz or the like may be used as the SCS.

Also, the number of symbols composing one slot may not be necessarily 14 symbols (for example, 28 or 56 symbols). Furthermore, the number of slots per subframe may be different depending on the SCS.

Note that the time direction (t) as illustrated in FIG. 3 may be referred to as a time domain, a symbol period or a symbol time or the like. Also, the frequency direction may be referred to as a frequency domain, a resource block, a subcarrier, a bandwidth part (BWP), or the like.

A Demodulation Reference Signal (DMRS) is a kind of reference signal and may be provided for various channels. Here, unless stated otherwise, the DMRS may mean a DMRS for a downlink data channel (specifically, a Physical Downlink Shared Channel (PDSCH)). However, the DMRS for an uplink data channel (specifically, a PUSCH) may be interpreted similar to the DMRS for the PDSCH.

The DMRS may be used as a part of coherent demodulation for channel estimation at a device (for example, the UE 200). The DMRS may exist in only a resource block (RB) for use in PDSCH transmission.

The DMRS may have several mapping types. Specifically, the DMRS may have mapping type A and mapping type B. In the mapping type A, the first DMRS may be assigned to the second or third symbol in a slot. According to the mapping type A, the DMRS may be mapped by using a slot boundary as a reference regardless of where actual data transmission is initiated in the slot. The reason of assignment of the first DMRS to the second or third symbol in the slot may be interpreted to cause the first DMRS to be assigned after a control resource set (CORESET).

In the mapping type B, the first DMRS may be assigned to the first symbol for data assignment. Namely, the position of DMRS may be provided relative to the assigned position of data rather than the slot boundary.

Also, the DMRS may have a plurality of types. Specifically, the DMRS may have Type 1 and Type 2. Type 1 differs from Type 2 in terms of mapping manners in the frequency domain and the maximum number of orthogonal reference signals. According to Type 1, up to four orthogonal signals can be output in a single-symbol DMRS, whereas according to Type 2, up to eight orthogonal signals can be output in a double-symbol DMRS.

The radio communication system 10 may support Coverage Enhancement (CE) for enhancement of the coverage of a cell (or a physical channel) formed by the gNB 100. In CE, some schemes for increasing a reception success rate for various physical channels such as a Msg 3 repetition may be provided.

For example, the UE 200 may receive information related to a random access (RACH) procedure as a downlink (DL) signal from the gNB 100. Also, for example, the UE may receive information related to the Msg 3 repetition as a DL signal from the gNB 100. For example, the information related to the Msg 3 repetition may include information indicative of resources for use in the Msg 3 repetition, the number of repetitions, frequency hopping patterns, indication offsets for use in the frequency hopping patterns, or the like.

For example, the UE 200 may transmit a special RACH occasion (RO) or preamble or the like for requesting for the Msg 3 repetition in the RACH procedure as an uplink (UL) signal to the gNB 100. Also, for example, the UE 200 may transmit Msg 3 to the gNB 100 repeatedly based on the information regarding the Msg 3 repetition received from the gNB 100 for the request for the Msg 3 repetition as an uplink signal.

For example, the UL signal may include data signals and control information for UL. For example, the UL signal may include information related to a processing capability of the UE 200 (for example, a UE capability). Also, the UL signal may include a reference signal.

For example, a data channel and a control channel may be included in channels for use in transmission of the UL signals. For example, the data channel may include a PUSCH, and the control channel may include a Physical Uplink Control Channel (PUCCH). For example, the UE 200 transmits control information by means of the PUCCH and an UL data channel by means of the PUSCH. Note that the PUSCH is one exemplary uplink shared channel, and the PUCCH is one exemplary uplink control channel. The shared channel may be referred to as a data channel.

The reference signal included in the UL signal may include at least one of a DMRS, a Phase Tracking Reference Signal (PTRS), a Channel State Information-Reference Signal (SRS) and a Positioning Reference Signal (PRS) for position information. For example, the reference signals such as the DMRS, the PTRS and the like may be used to demodulate the UL data signals and are transmitted in the PUSCH.

A RACH procedure of NR is performed for initial access from RRC_Idle, (re)establishment of an RRC connection, recovery of beam failure, handover, downlink data arrival, uplink data arrival, positioning, Timing Alignment (TA) and the like. The RACH procedure includes a Contention Based Random Access (CBRA) procedure and a Contention Free Random Access (CFRA) procedure. In the CBRA procedure, since the UE 200 is voluntarily activated, contention may arise due to simultaneous initiation of the RACH procedure by a plurality of UEs 200. In the CFRA procedure, on the other hand, the GNB 100 instructs a connecting UE 200 to conduct the RACH procedure so that no contention can arise among the plurality of UEs 200.

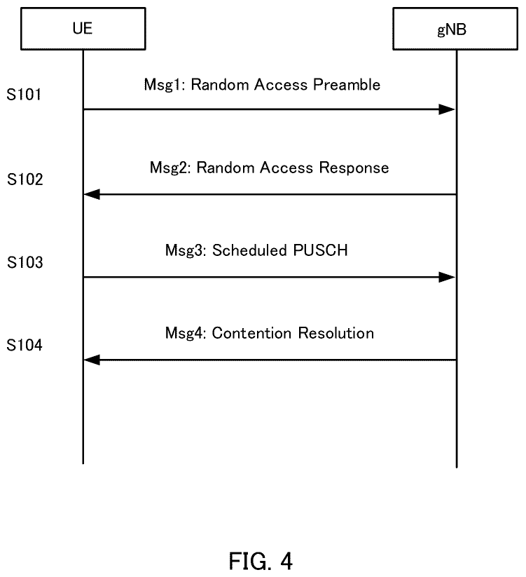

FIG. 4 is a sequence diagram for illustrating the CBRA procedure according to one embodiment of the present disclosure. As illustrated in FIG. 4, at step S101, the UE 200 transmits a random access (RA) preamble as a first message (Msg 1) in a Physical Random Access Channel (PRACH).

At step S102, the UE 200 receives a response message (Random Access Response (RAR)) to the Msg 1 as a second message (Msg 2) in a PDSCH. After transmitting Msg 1, the UE 200 may monitor a PDCCH for use in scheduling of the PDSCH including Msg 2. A CRC bit included in the PDCCH may be scrambled with a Random Access-Radio Network Temporary Identifier (RA-RNTI). The Msg 2 may include an uplink grant (RAR uplink grant) for use in scheduling the PUSCH including the Msg 3. The RAR uplink grant may include a Temporary Cell-RNTI (TC-RNTI). The RAR uplink grant may include a TPC command indicative of a correction value for a power control value for use in transmit power of the PUSCH including the Msg 3.

At step S103, the UE 200 transmits the PUSCH scheduled in the RAR uplink grant as a third message (Msg 3). For example, the UE 200 transmits an RRC connection request, an RRC connection re-establishment request and other to the gNB 100 via the PUSCH. Here the UE 200 may transmit the PUSCH for the Msg 3 repeatedly for coverage enhancement.

At step S104, the UE 200 receives a contention resolution message as a fourth message (Msg 4) in the PDCCH. After transmitting the Msg 3, the UE 200 may monitor the PDCCH for use in scheduling the PDSCH including the Msg 4. The Msg 4 may include a contention resolution ID (UE contention resolution ID). The contention resolution ID may be used to resolve contention arising from transmissions of signals in the same radio resources from multiple UEs 200. If the contention resolution ID included in the Msg 4 received at the UE 200 is the same as the ID value for identifying the UE 200, the UE 200 may determine that the contention resolution is successful and set a TC-RNTI value to a C-RNTI field. When the TC-RNTI value is set to the C-RNTI field, the UE 200 may consider that the RRC connection has been completed. The Msg 4 may be referred to as an RRC Connection Setup.

Upon completion of the RRC connection, the UE 200 may transmit an Ack in a PUCCH (PUCCH resource) indicated in a PUCCH resource indication field included in the PDCCH used for scheduling the Msg 4 to indicate the completion of the RRC connection to the gNB 100. Also, the UE 200 may transmit a UE capability to the gNB 100 after the completion of the RRC connection. The above-stated RACH procedure may be referred to as Type 1 RACH procedure, 4-step RACH procedure, Type 1 RACH, 4-step RACH and the like.

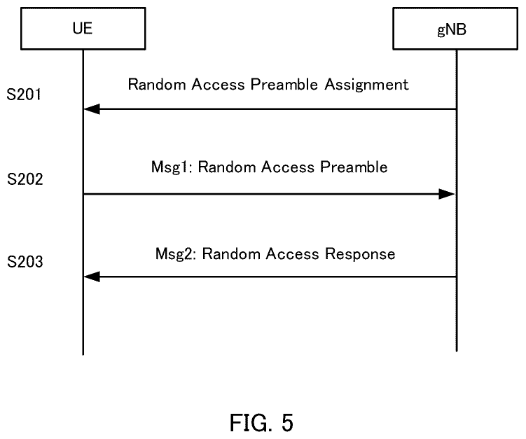

FIG. 5 is a sequence diagram for illustrating the CFRA procedure according to one embodiment of the present disclosure. As illustrated in FIG. 5, at step S201, the UE 200 is requested by the gNB 100 to transmit an RA preamble (Msg 1). The gNB 100 may assign the RA preamble (Msg 1) via a dedicated signaling. A PDCCH for the dedicated signaling may be referred to as a PDCCH order. The UE 200 monitors the PDCCH (PDCCH order) to assign a resource for the Msg 1.

At step S202, the UE 200 transmits the above-stated Msg 1.

At step S203, the UE 200 receives the above-stated Msg 2. Upon completion of the RRC connection, the UE 200 may transmit an Ack in a PUCCH (PUCCH resource) to indicate the completion of the RRC connection to the gNB 100. Also, after establishment of the RRC connection, the UE 200 may transmit a UE capability to the gNB 100 to indicate whether to support repetitive transmissions of Msg 3.

A plurality of types of PUSCH repetition may be defined. Specifically, Repetition type A and Repetition type B may be defined. The Repetition type A may be interpreted as an implementation where the PUSCH assigned within a slot is repeatedly transmitted. In other words, the PUSCH is assigned to smaller than or equal to 14 symbols and cannot be assigned across a plurality of slots (adjacent slots)

On the other hand, the Repetition type B may be interpreted as the PUSCH repetition where the PUSCH may be assigned to greater than or equal to 15 symbols. In the present embodiment, assignment of the PUSCH across multiple slots may be acceptable.

Also, multiple types of UEs 200 may be used in the radio communication system 10. For example, multiple types of terminals having different functionalities, capabilities or others or supporting different 3GPP Releases may exist as the UEs 200. The terminals (UEs) may be referred to as a first type of terminal and a second type of terminal. Also, the types may be replaced with other terminologies such as generations, Releases or the like. The first and second types of terminals may be referred to as an enhanced UE and a legacy UE, respectively. For example, the enhanced UE may be interpreted as the UE that supports the Msg 3 repetition, and the legacy UE may be interpreted as the UE that does not support the Msg 3 repetition.

### Consideration

It is agreed that when PUSCH repetition of the Msg 3 is configured in the random access procedure, the number of repetitions of the PUSCH of the Msg 3 for retransmission (that is, the PUSCH scheduled by DCI format 0_0 with a CRC scrambled by a TC-RNTI) is determined by the UE 200 based on a Modulation and Coding Scheme (MCS) field in DCI used for scheduling.

In initial transmission of the PUSCH repetition of the Msg 3 (the PUSCH scheduled by an RAR UL grant), the most significant two bits of the MCS field are used to indicate the number of repetitions, and candidate values of the MCS indices and the numbers of repetitions are indicated in system information (for example, a SIB 1). If the candidate values are not configured in the system information, MCS indices 0 to 3 and the numbers of repetitions {1, 2, 3, 4} are applied as the candidate values. Also, it is agreed that the MCS field in an RAR uplink grant is used to indicate the number of repetitions for initial transmission of the PUSCH of the Msg 3. Here, the MCS field is of four bits in the RAR uplink grant, and the MCS field is of five bits in DCI with a CRC scrambled by a TC-RNTI. It is agreed that the four MCS indices can be configured by the SIB 1 for initial transmission of the Msg 3, and if the configuration is not present, the MCS 0 to 3 are applied. Also, if four candidates of the numbers of repetition are not configured, the default candidate values {1, 2, 3, 4} are applied.

Furthermore, it is agreed that a mechanism similar to initial transmission of the PUSCH of the Msg 3 is used for the number of repetitions for retransmission of the PUSCH of the Msg 3, but the MCS indices used for retransmission of the PUSCH of the Msg 3 are not currently agreed.

### Solutions

The UE 200 determines the MCS and the number of repetitions from the MCS field in an uplink grant (DCI format 0_0 with a CRC scrambled by a TC-RNTI) for repetitive transmissions of an uplink data channel for retransmission in the random access procedure and transmits the uplink data channel for retransmission repeatedly in accordance with the MCS and the number of repetitions as determined. Namely, if repetitive transmissions of the PUSCH of the Msg 3 are configured, the UE 200 may determine the MCS index and the number of repetitions from the MCS field in the uplink grant for applying an interpretation of the uplink grant for instructing the Msg 3 repetition and repeatedly transmit the PUSCH for retransmission in accordance with the MCS and the number of repetitions as determined.

In one embodiment, the UE 200 may determine the number of bits indicative of the MCS or the number of bits indicative of the number of repetitions in the MCS field based on the system information. As stated above, the MCS field is of four bits in an RAR uplink grant, and the MCS field is of five bits in DCI with a CRC scrambled by a TC-RNTI. The UE 200 may determine the number of repetitions from the most (or the least) significant two or three bits in the MCS field and determine the MCS index from the remaining two or three bits. Here, indication as to how many bits of the most (or the least) significant bits of the MCS field is used to indicate the number of repetitions or the MCS index may be made in the system information such as SIB 1. In this manner, the UE 200 can identify the number of repetitions for the PUSCH repetition of the Msg 3 for retransmission and the MCS applied in the retransmission based on the system information.

In one embodiment, the UE 200 may determine the MCS for repetitive transmission of an uplink data channel for retransmission based on MCS mapping information used for initial transmission. The MCS indices are associated with bit values in the mapping information, and the UE 200 may reapply the mapping information used for the PUSCH repetition of the Msg 3 for initial transmission in the random access procedure for the PUSCH repetition of the Msg 3 for retransmission.

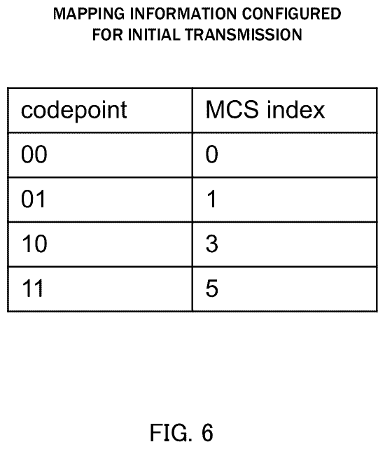

For example, if the MCS index is determined from two bits of the MCS field, the UE 200 may reapply the mapping information applied for initial transmission for retransmission. Specifically, the UE 200 may determine the MCS index from the two bits of the MCS field in accordance with the mapping table as illustrated in FIG. 6.

On the other hand, if the MCS index is determined from three bits of the MCS field, the UE 200 may determine which MCS is to be applied with reference to mapping of the MCS index applied for initial transmission to a code point of the most (or the least) significant two bits of three bits, and the remaining one bit may be used as a reserved bit (Opt. 1-1).

Alternatively, if the MCS index can be determined from the three bits of the MCS field, the UE 200 may determine whether to reuse the mapping of MCS indices, which is applied for initial transmission, for retransmission based on the most (or the least) significant one bit of the three bits and determine one of the MCS indices to be applied with reference to the MCS indices based on the remaining two bits (Opt. 1-2). If the mapping of MCS indices applied for initial transmission is not reused for retransmission, the UE 200 may determine the MCS index in the mapping table based on a predetermined rule as stated below or the system information.

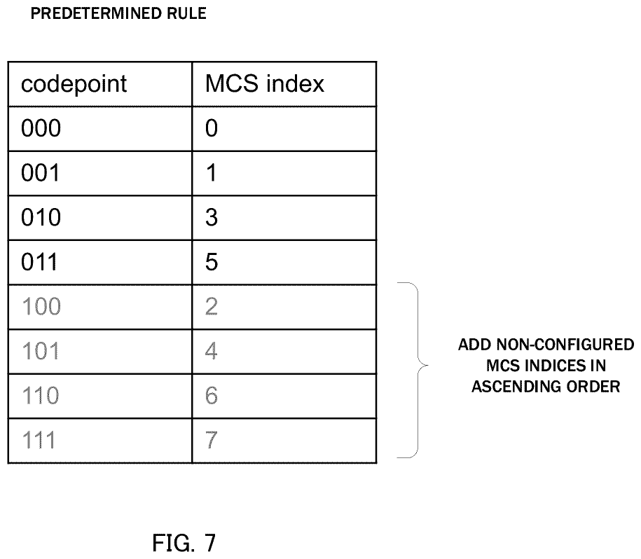

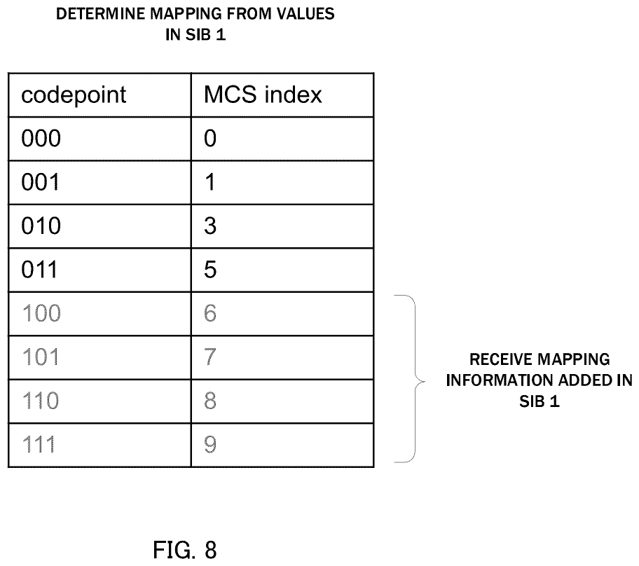

Alternatively, if the MCS index is determined from the three bits of the MCS field, the UE 200 may add other MCS indices to the mapping information applied for initial transmission and determine the MCS index for retransmission based on the mapping table including the added MCS indices and s code point of three bits. Specifically, ones of the added MCS indices that have not been configured may be added to the mapping information in the ascending order from MCS index 0. Then, the MCS indices that have been already included may not be added. For example, as illustrated in FIG. 7, the MCS indices that have not been configured yet to the mapping information applied for initial transmission are added in the ascending order. Alternatively, the added MCS indices may be configured by the system information or RRC. For example, as illustrated in FIG. 8, the MCS indices configured by SIB 1 may be added to the mapping information applied for initial transmission.

Alternatively, if the MCS index is determined from three bits of the MCS field, the UE 200 may configure the mapping information base on a predetermined rule (Opt. 2). For example, the mapping information may represent MCS indices 0 to 3 with two bits and MCS indices 0 to 7 with three bits, and the UE 200 may determine the MCS index in accordance with the mapping information. In this case, the MCS indices 0 to 3 could be represented with both the two bits and the three bits.

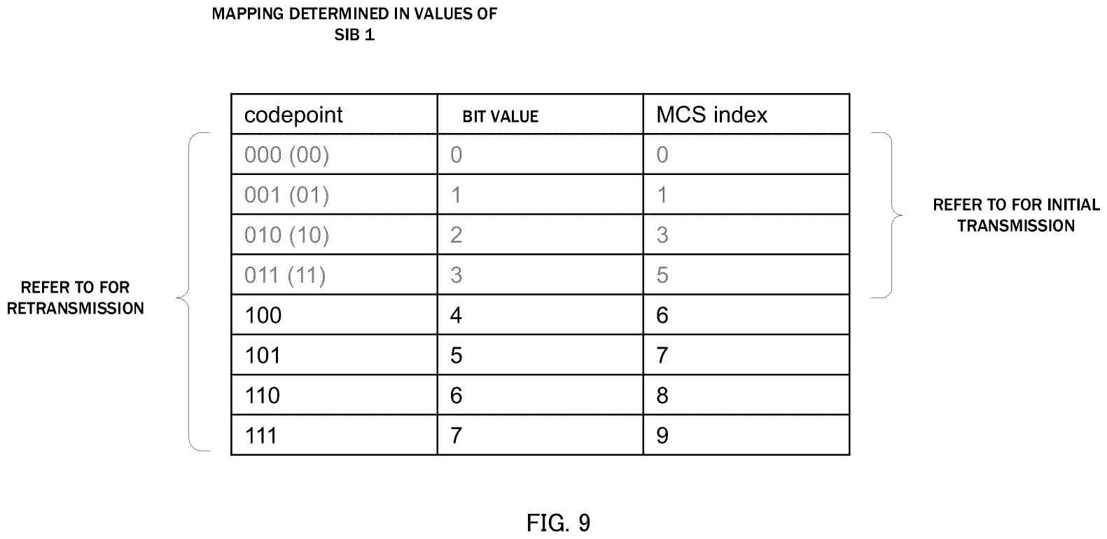

Alternatively, if the MCS index is determined from three bits of the MCS field, the UE 200 may configure the mapping information based on the system information (Opt. 3). For example, each of a mapping between bit values (code points) of the MCS field in an uplink grant for initial transmission and the MCS indices and a mapping between bits values (code points) of the MCS field in an uplink grant for retransmission and the MCS indices may be configured in the system information (for example, SIB 1). Alternatively, a common mapping for initial transmission and retransmission between bit values (code points) of the MCS field and the MCS indices may be configured in the system information (for example, SIB 1). For example, in initial transmission, 0 (or 1) is assigned to the most significant bit, and the mapping information may be referred to. Specifically, the amping information as illustrated in FIG. 9 may be configured. According to the mapping information, MCS indices 0 to 3 can be referred to for both initial transmission and retransmission, and MCS indices 0 to 7 can be referred to for retransmission. The bits values herein may be interchangeably referred to as code points.

Opts. 1 to 3 as stated above may be applied in combination. For example, if the mapping information between the MCS indices and the bits values is configured in SIB 1, the UE 200 may apply Opt. 3, and if the mapping information between the MCS indices and the bit values is not configured in SIB 1, the UE 200 may apply Opt. 2.

Meanwhile, for mapping between the number of repetitions for repetitive transmissions of a PUSCH of Msg 3 for retransmission and the bit values, the “MCS indices” in the mapping between the MCS indices and the bit values as stated above may be replaced with “the numbers of repetitions”.

Also, the mapping information may be composed of a combination of bit values (code points) of the MCS field, the numbers of repetitions and the MCS indices. For example, the UE 200 may receive such mapping information in the system information or RRC and determine the MCS index and the number of repetitions based on the received mapping information.

As one example, the mapping information may be configured for each of a PUSCH scheduled by an RAR UL grant for Msg 3 repetition for initial transmission and a PUSCH schedule by DCI format 0_0 with a CRC scrambled by a TC-RNTI for Msg 3 repetition for retransmission.

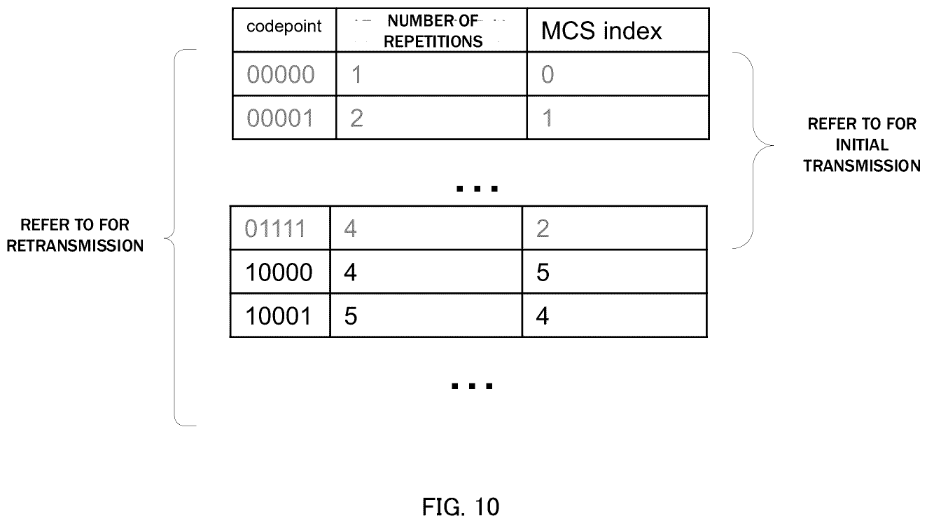

As another example, the mapping information may be configured to include a mapping that is partially or fully common to a PUSCH scheduled by an RAR UL grant for Msg 3 repetition for initial transmission and a PUSCH scheduled by DCI format 0_0 with a CRC scrambled by a TC-RNTI for Msg 3 repetition for retransmission. For example, as illustrated in FIG. 10, the mapping information may be arranged from combinations of bit values of five bits, the numbers of repetitions and the MCS indices. The least significant four bits may be only referred to for initial transmission, and all candidate values may be referred to for retransmission. For example, in initial transmission, 0 (or 1) may be assigned to the most significant bit, and the mapping information may be referred to. Also, as illustrated in FIG. 10, a mapping portion for initial transmission may be configured, the mapping portion may be referred to for initial transmission whereas the whole mapping information may be referred to for retransmission.

### Variations

Although combinations of the numbers of repetitions and the MCS indices for PUSCH repetition scheduled for retransmission are focused on in the above-stated embodiments, the present disclosure, but is not limited to it, may be applied to combinations of other parameters for controlling the repetitions and other parameters composing an uplink grant.

According to the above-stated solutions, the MCS index and the number of repetitions in the MCS field can be flexibly configured for Msg 3 repetitions for retransmission.

### Apparatus Arrangement

Next, exemplary functional arrangements of the gNB 100 and the UE 200 that implement operations and actions as described above is described. The gNB 100 and the UE 200 include functionalities for achieving the above-stated embodiments. However, the gNB 100 and the UE 200 each may include only a part of the functionalities in the embodiments.

### gNB 100

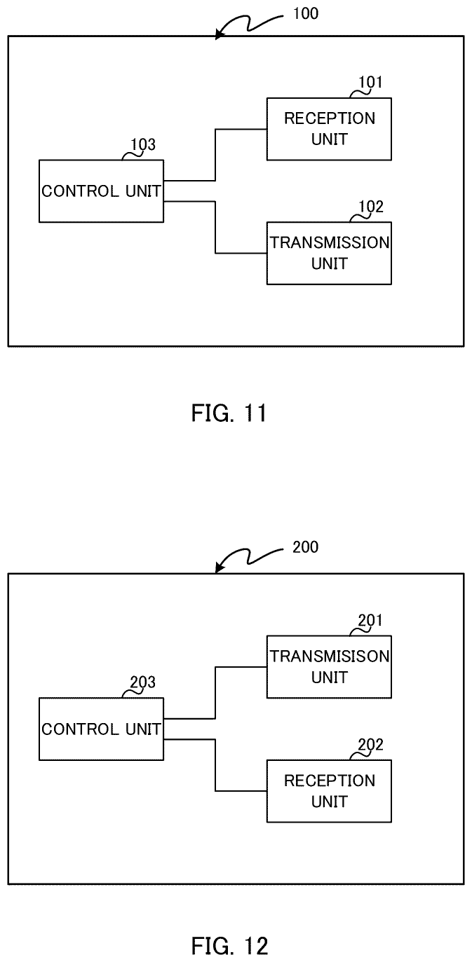

FIG. 11 is a diagram for illustrating one exemplary functional arrangement of the gNB 100. As illustrated in FIG. 11, the gNB 100 includes a reception unit 101, a transmission unit 102 and a control unit 103. The functional arrangement as illustrated in FIG. 11 is merely illustrative. As long as actions according to embodiments of the present invention can be implemented, separation and names of functionalities may be arbitrary.

The reception unit 101 includes functionalities of receiving various signals transmitted from the UE 200 and obtaining information on upper layers from the received signals, for example. The transmission unit 102 includes functionalities of generating signals for transmission to the UE 200 and transmitting the signals in a wired or wireless manner.

The control unit 103 stores preconfigured configurations and various configurations for transmission to the UE 200 in a storage device and reads them from the storage device as needed. Also, the control unit 103 performs operations associated with communication with the UE 200. Functional units in the control unit 103 related to signal transmission may be included in the transmission unit 102, and functional units in the control unit 103 related to signal reception may be included in the reception unit 101.

### UE 200

FIG. 12 is a diagram for illustrating one exemplary functional arrangement of the UE 200. As illustrated in FIG. 12, the UE 200 includes a transmission unit 201, a reception unit 202 and a control unit 203. The functional arrangement as illustrated in FIG. 12 is merely illustrative. As long as actions according to embodiments of the present invention can be implemented, separation and names of functionalities may be arbitrary.

The transmission unit 201 generates transmission signals from transmission data and transmits the transmission signals in a wireless manner. The reception unit 202 receives various signals in a wireless manner and obtains signals for upper layers from the received signals of a physical layer. Also, the reception unit 202 has functionalities of receiving an NR-PSS, an NR-SSS, an NR-PBCH, a DL/UL control signal, a reference signal or the like transmitted from the gNB 100.

The control unit 203 stores various configurations received at the reception unit 202 from the gNB 100 in a storage device and reads them from the storage device as needed. Also, the control unit 203 performs operations associated with communication with the gNB 100. Functional units in the control unit 203 related to signal transmission may be included in the transmission unit 201, and functional units in the control unit 203 related to signal reception may be included in the reception unit 202.

### Hardware Arrangement

Note that, the block diagrams used to describe the above embodiment illustrate blocks on the basis of functions. These functional blocks (components) are implemented by any combination of at least hardware or software items. Implementation manners of the functional blocks are not particularly limited. That is, the functional blocks may be implemented using one physically or logically coupled apparatus. Also, two or more physically or logically separate apparatuses may be directly or indirectly connected (for example, via wires or in the air), and the plurality of apparatuses may be used to implement the functional blocks. The functional blocks may be implemented by combining software items with the one apparatus or the plurality of apparatuses described above.

The functions may include, but not limited to, judging, deciding, determining, computing, calculating, processing, deriving, investigating, searching, confirming, receiving, transmitting, outputting, accessing, solving, selecting, choosing, establishing, comparing, supposing, expecting, regarding, broadcasting, notifying, communicating, forwarding, configuring, reconfiguring, allocating, mapping, assigning, and the like. For example, a functional block (component) that functions to achieve transmission is referred to as “a transmitting unit” or “a transmitter”. The implementation manners of the functions are not particularly limited as described above.

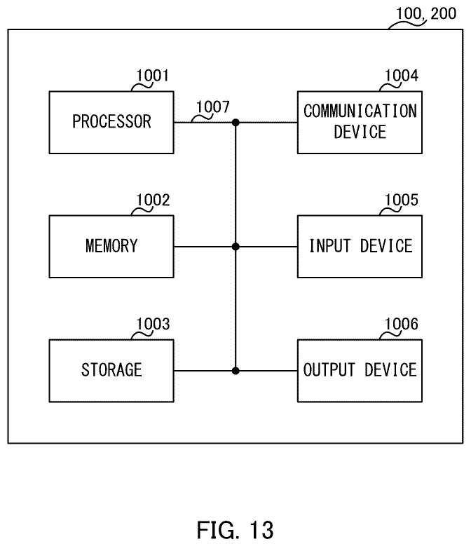

For example, the gNB 100 and the UE 200 and the like according to one embodiment of the present disclosure may function as a computer that executes processing of radio communication methods of the present disclosure. FIG. 13 illustrates an exemplary hardware arrangement of the gNB 100 and the UE 200 according to one embodiment of the present disclosure. The gNB 100 and the UE 200 as stated above may be physically arranged as a computer device including a processor 1001, a memory 1002, a storage 1003, a communication device 1004, an input device 1005, an output device 1006, a bus 1007, and the like.

Note that the term “apparatus” in the following description can be replaced with a circuitry, a device, a unit, or the like. The hardware arrangements of the gNB 100 and the UE 200 may include one or more of the devices illustrated in FIG. 13 or may not include a part of the devices.

The functions of the gNB 100 and the UE 200 may be implemented by predetermined software items (programs) loaded into a hardware item, such as the processor 1001, the memory 1002, and the like, to cause the processor 1001 to perform an operation or control communication by the communication device 1004 or at least one of reading and writing of data from/in the memory 1002 and the storage 1003.

The processor 1001 executes an operating system to control the entire computer, for example. The processor 1001 may be composed of a central processing unit (CPU) including an interface with peripheral devices, a controller, an arithmetic device, a register, and the like. For example, the control units 103 and 203 and the like as described above may be implemented using the processor 1001.

Also, the processor 1001 loads a program (program code), a software module, data, and the like from at least one of the storage 1003 and the communication device 1004 to the memory 1002 and performs various types of processing in accordance with the program (program code), the software module, the data, and the like. As the program, a program for causing the computer to perform at least a part of the operations described in the above embodiments may be used. For example, the control units 103 and 203 of the gNB 100 and the UE 200 may be implemented using a control program stored in the memory 1002 and executed by the processor 1001, and the other functional blocks may also be implemented similarly. While it has been described that the various types of processing as described above may be performed by the single processor 1001, the various types of processing may be performed by the two or more processors 1001 in parallel or sequentially. The processor 1001 may be implemented using one or more chips. Note that the program may be transmitted from a network through a telecommunication line.

The memory 1002 is a computer-readable storage medium and may be composed of, for example, at least one of a Read Only Memory (ROM), an Erasable Programmable ROM (EPROM), an Electrically Erasable Programmable ROM (EEPROM), and a Random Access Memory (RAM). The memory 1002 may be called as a register, a cache, a main memory (main storage device), or the like. The memory 1002 can save a program (program code), a software module, and the like that can be executed to perform a radio communication method according to one embodiment of the present disclosure.

The storage 1003 is a computer-readable storage medium and may be composed of, for example, at least one of an optical disk such as a Compact Disc ROM (CD-ROM), a hard disk drive, a flexible disk, a magneto-optical disk (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may also be called as an auxiliary storage device. The storage medium as described above may be, for example, a database, a server, or other appropriate media including at least one of the memory 1002 and the storage 1003.

The communication device 1004 is hardware (transceiver device) for communication between computers through at least one of wired and wireless networks and is also called as, for example, a network device, a network controller, a network card, or a communication module. The communication device 1004 may be configured to include a high frequency switch, a duplexer, a filter, a frequency synthesizer, and the like in order to achieve at least one of Frequency Division Duplex (FDD) and Time Division Duplex (TDD), for example. For example, an antenna and the like in the gNB 100 and the UE 200 may be implemented using the communication device 1004.

The input device 1005 is an input device (for example, a keyboard, a mouse, a microphone, a switch, a button, or a sensor) that receives inputs from the outside. The output device 1006 is an output device (for example, a display, a speaker, or an LED lamp) which feeds outputs to the outside. Note that the input device 1005 and the output device 1006 may be integrated (for example, a touch panel).

Also, the respective devices, such as the processor 1001, the memory 1002, and the like are connected by the bus 1007 for communication of information. The bus 1007 may be arranged using a single bus or using buses different between each pair of the devices.

Also, the respective devices, such as the processor 1001, the memory 1002, and the like are connected by the bus 1007 for communication of information. The bus 1007 may be arranged using a single bus or using buses different between each pair of the devices. Also, the respective devices, such as the processor 1001, the memory 1002, and the like are connected by the bus 1007 for communication of information. The bus 1007 may be arranged using a single bus or using buses different between each pair of the devices.

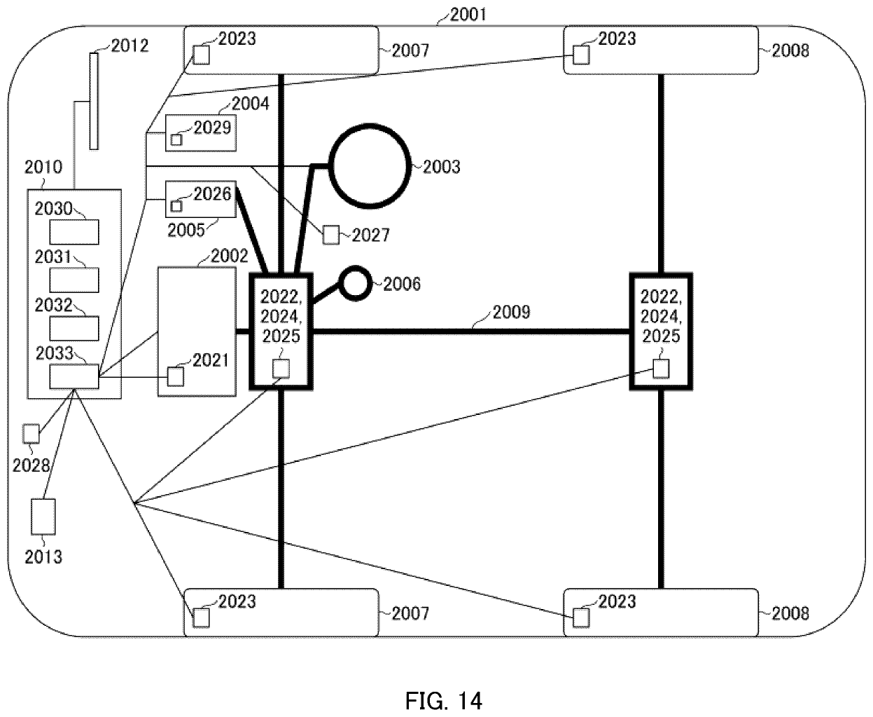

FIG. 14 illustrates an exemplary arrangement of a vehicle 2001. As illustrated in FIG. 14, the vehicle 2001 includes a driving unit 202, a steering unit 2003, an accelerator pedal 2004, a brake pedal 2005, a shift lever 2006, front wheels 2007, rear wheels 2008, an axle 2009, an electronic controller 2010, various sensors 2021 to 2029, an information service unit 2012 and a communication module 2013. The embodiments or implementations described in the present disclosure may be applied to a communication device incorporated in the vehicle 2001, for example, to the communication module 2013.

The driving unit 2002 may be composed of an engine, a motor or a hybrid of the engine and the motor, for example. The steering unit 2003 may at least include a steering wheel (which is also called a handle) and be arranged to steer at least one of the front wheels and the rear wheels based on user's operation of the steering wheel.

The electronic controller 2010 is composed of a microprocessor 2031, a memory (ROM, RAM) 2032 and a communication port (IO port) 2033. Signals from the various sensors 2021 to 2029 incorporated in the vehicle 2001 are fed to the electronic controller 2010. The electronic controller 2010 may be referred to as an ECU (Electronic Control Unit).

The signals fed from the various sensors 2021 to 2029 may include a current signal from a current sensor 2021 for sensing the current of a motor, an engine speed signal for the front or rear wheels obtained with an engine speed sensor 2022, an air pressure signal for front or rear wheels obtained with an air pressure sensor 2033, a vehicle speed signal obtained with a vehicle speed sensor 2024, an acceleration signal obtained with an acceleration sensor 2025, a stepping-in amount signal of an accelerator pedal obtained with an accelerator pedal sensor 2029, a stepping-in amount signal of a brake pedal obtained with a brake pedal sensor 2026, an operating signal of a shift lever obtained with a shift lever sensor 2027, and a detection signal for detecting an obstacle, a vehicle, a pedestrian and the like obtained with an object detection sensor 2028.

The information service unit 2012 may be composed of various equipments for providing various information items such as driving information, traffic information, entertainment information, for example, a car navigation system, an audio system, a speaker, a television set and a radio set, and one or more ECUs for controlling these equipments. The information service unit 2012 may use information obtained from an external device via the communication module 2013 and the like to provide various multimedia information items and multimedia services to an occupant in the vehicle 2001.

A driving assistance system unit 2030 may be composed of various equipments for providing functionalities for preventing an accident before it happens or reducing driving load of a driver, for example, a millimeter-wave radar, a LiDAR (Light Detection and Ranging), a camera, a positioning locator (for example, a GNSS or the like), map information (for example, a high definition (HD) map, an autonomous vehicle (AV) map and the like), a gyro system (for example, an IMU (inertial Measurement Unit), an INS (Inertial Navigation System) and the like), an AI (Artificial Intelligence) chip, and an AI processor, and one or more ECUs for controlling these equipments. Also, the driving assistance system unit 2030 may transmit and receive various information items via the communication module 2013 to implement a driving assistance functionality and an autonomous driving functionality.

The communication module 2013 may communicate with the microprocessor 2031 and components in the vehicle 2001 via a communication port. For example, the communication module 2013 transmits and receives data to and from the driving unit 2002, the steering unit 2003, the accelerator pedal 2004, the brake pedal 2005, the shift lever 2006, the front wheels 2007, the rear wheels 2008 and the axle 2009 provided in the vehicle 2001, the microprocessor 2031 and the memory (ROM, RAM) 2032 in the electronic controller 2010 and the sensors 2021 to 2029.

The communication module 2013 is a communication device that can be controlled by the microprocessor 2031 in the electronic controller 2010 and communicate with an external device. For example, the communication module 2013 may transmit and receive various information items to and from the external device in the air. The communication module 2013 may be inside or outside the electronic controller 2010. The external device may be a base station, a mobile station and the like, for example.

The communication module 2013 mat transmit a current signal fed to the electronic controller 2010 from a current sensor to an external device via wireless communication. Also, the communication module 2013 transmits to an external device via wireless communication: an engine speed signal for the front or rear wheels obtained with the engine speed sensor 2022, an air pressure signal of the front or rear wheels obtained with the air pressure sensor 2023, a vehicle speed signal obtained with the vehicle speed sensor 2024, an acceleration signal obtained with the acceleration sensor 2025, a stepping-in amount signal of an accelerator pedal obtained with the accelerator pedal sensor 2029, a brake pedal stepping-in amount signal of a brake pedal obtained with the brake pedal sensor 2026, an operation signal for a shift lever obtained with the shift lever sensor 2027, a detection signal for detecting an obstacle, a vehicle, a pedestrian or the like obtained with an object detection sensor 2028 or the like, which are fed to the electronic controller 2010.

The communication module 2013 receives various information items (traffic information, traffic light information, vehicle distance information and others) and displays the information items to the information service unit 2012 installed into the vehicle 2001. Also, the communication module 2013 stores the information items received from an external device in the memory 2032 available to the microprocessor 2031. The driving unit 2002, the steering unit 2003, the accelerator pedal 2004, the brake pedal 2005, the shift lever 2006, the front wheels 2007, the rear wheels 2008, the axle 2009, the sensors 2021 to 2029 and others may be controlled based on the information items stored in the memory 2032.

### Summary of Embodiments

As stated above, according to one aspect of the present disclosure, there is provided a terminal, comprising: a control unit that determines a Modulation and Coding Scheme (MCS) and a number of repetitions from an MCS field in an uplink grant for repetitive transmissions of an uplink data channel for retransmission in a random access procedure; and a transmission unit that repeatedly transmits the uplink data channel for retransmission in the random access procedure in accordance with the MCS and the number of repetitions.

According to the above arrangement, the MCS index and the number of repetitions in the MCS field can be flexibly configured in repetitive transmissions of an uplink data channel for retransmission.

Also, according to one embodiment, the control unit may determine a number of bits indicative of the MCS or a number of bits indicative of the number of repetitions in the MCS field based on system information. According to this embodiment, one or more bits indicative of the MCS and one or more bits indicative of the number of repetitions in the MCS field can be identified based on the system information.

Also, according to one embodiment, the control unit may determine the MCS for repetitive transmission of the uplink data channel for retransmission based on MCS mapping information used for initial transmission. According to this embodiment, the MCS mapping information used for initial transmission can be used to configure mapping information of the MCS indices for retransmission.

Also, according to one embodiment, the control unit may determine MCS mapping information based on a predetermined rule or system information. According to this embodiment, the mapping information of the MCS indices for retransmission can be easily configured.

Also, according to one aspect of the present disclosure, there is provided a base station, comprising: a control unit that configures a Modulation and Coding Scheme (MCS) and a number of repetitions in an MCS field of an uplink grant for repetitive transmissions of an uplink data channel for retransmission in a random access procedure; and a reception unit that repeatedly receives the uplink data channel for retransmission in the random access procedure in accordance with the MCS and the number of repetitions.

According to the above arrangement, the MCS index and the number of repetitions in the MCS field can be flexibly configured in repetitive transmissions of an uplink data channel for retransmission.

According to one aspect of the present disclosure, there is provided a radio communication method implemented by a terminal, comprising: determining a Modulation and Coding Scheme (MCS) and a number of repetitions from an MCS field in an uplink grant for repetitive transmissions of an uplink data channel for retransmission in a random access procedure; and repeatedly transmitting the uplink data channel for retransmission in the random access procedure in accordance with the MCS and the number of repetitions.

According to the above arrangement, the MCS index and the number of repetitions in the MCS field can be flexibly configured in repetitive transmissions of an uplink data channel for retransmission.

### Supplement of Embodiments

Although the embodiments of the present invention have been described above, the disclosed invention is not limited to the embodiments, and it could be understood by those skilled in the art that various variations, modifications, substitutions, replacements and others may be made. In order to facilitate understandings of the present invention, the embodiments have been described by means of specific numerical values. Unless otherwise specified, these numerical values are merely illustrative, and any appropriate values may be used. Separation of items in the above description is not essential to the present invention, but matters described in conjunction with two or more items may be combined and used if necessary, or matters described in conjunction with a certain item may be applied to matters described in conjunction with other items (unless the matters are inconsistent). The boundaries of functional units or processing units in functional block diagrams may not necessarily correspond to the boundaries of physical components. Operations of the plurality of functional units may be performed physically by one component, or an operation of one functional unit may be performed physically by a plurality of components. For procedures described in the embodiments, the order of processes may be switched without being inconsistent. For convenience of description of the processes, the gNB 100 and the UE 200 have been described with reference to the functional block diagrams. However, these apparatuses may be implemented by hardware, software, or a combination thereof. Each of software items executed by the processor included in radio communication node 10 according to the embodiments of the present invention and software items executed by the processor included in the terminal 20 according to the embodiments of the present invention may be stored in a random access memory (RAM), a flash memory, a read-only memory (ROM), an EPROM, an EEPROM, a register, a hard disk drive (HDD), a removable disk, a CD-ROM, a database, a server or other appropriate storage media.

### Indication of Information and Signaling

Indication of information is not limited to the aspects or embodiments described in the present disclosure, and the information may be indicated in other manners. For example, information may be indicated or signaled by a physical layer signaling (for example, Downlink Control Information (DCI) and Uplink Control Information (UCI)), upper layer signaling (for example, Radio Resource Control (RRC) signaling, Medium Access Control (MAC) signaling, broadcast information (Master Information Block (MIB), and System Information Block (SIB))) or other signals or combinations thereof. Also, the RRC signaling may be referred to as an RRC message and may be, for example, an RRC connection setup message, an RRC connection reconfiguration message, or the like.

### Applied System

The aspects and embodiments described in the present disclosure may be applied to at least one of systems using Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark) or other appropriate systems and a next-generation system enhanced based on the above systems. Also, combinations of multiple systems (e.g., a combination of at least LTE or LTE-A and 5G) may be applied.

### Processing Procedure and the Like

The orders of the processing procedures, the sequences, the flow charts, and the like of the aspects and embodiments described in the present disclosure may be changed as long as there is no contradiction. For example, for the methods described in the present disclosure, elements of various steps are presented in exemplary orders, but the methods are not limited to the presented specific orders.

### Operation of IAB Node

In some cases, specific operations which are described in the present disclosure as being performed by the IAB node may be performed by an upper node. Various operations performed for communication with a terminal in a network constituted by one or more network nodes including the IAB node can be obviously performed by at least one of the IAB node and a network node other than the IAB node (for examples, an MME or a S-GW, but not limited to, may be conceived). Although the case where there is one network node in addition to the IAB node has been illustrated above, a plurality of other network nodes may be combined (for example, an MME and an S-GW).

### Direction of Input and Output

Information and the like (the item “information and signaling” may be referred to) can be fed from a higher layer (or a lower layer) to a lower layer (or a higher layer). The information and the like may be fed in or out through a plurality of network nodes.

### Handling of Input and Output Information and the Like

Input and output information and the like may be saved in a specific place (for example, a memory) or may be managed using a management table. The input and output information and the like can be overwritten, updated, or additionally written. The output information and the like may be deleted. The input information and the like may be transmitted to another apparatus.

### Determination Method

Determination may be made based on a value represented by one bit (0 or 1), based on a Boolean value (true or false), or based on comparison with a numerical value (for example, comparison with a predetermined value).

### Software

Regardless of whether the software is called as software, firmware, middleware, a microcode, or a hardware description language or by another name, the software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, and the like.

Also, the software, the instruction, the information, and the like may be transmitted and received through a transmission medium. For example, if the software is transmitted from a website, a server, or another remote source by using at least one of a wired technique (e.g., a coaxial cable, an optical fiber cable, a twisted pair, and a digital subscriber line (DSL)) and a wireless technique (e.g., an infrared ray and a microwave), the at least one of the wired technique and the wireless technique is included in the definition of the transmission medium.

### Information and Signal

The information, the signals, and the like described in the present disclosure may be represented by using any of various different techniques. For example, data, instructions, commands, information, signals, bits, symbols, chips, and the like that may be mentioned throughout the above description may be represented by voltage, current, electromagnetic waves, magnetic fields, magnetic particles, optical fields or photons or arbitrary combinations thereof.

Note that terminologies described in the present disclosure and terminologies necessary to understand the present disclosure may be replaced with those having the same or similar meaning. For example, at least one of channels and symbols may be a signal (signaling). The signal may be a message. Also, a component carrier (CC) may be called a carrier frequency, a cell, a frequency carrier, or the like.

### “System” and “Network”

The terms “system” and “network” used in the present disclosure can be interchangeably used.

### Names of Parameters and Channels

Information, parameters, and the like described in the present disclosure may be represented using an absolute value, using a value relative to a predetermined value, or using other corresponding information. For example, radio resources may be indicated by indices.

The names used for the above-stated parameters are not limitative in any respect. Furthermore, the numerical formulas and the like using the parameters may be different from the ones explicitly disclosed in the present disclosure. Various channels (for example, a PUCCH and a PDCCH) and information elements can be identified by any suitable names, and various names assigned to these various channels and information elements are not limitative in any respect.

### Base Station (Radio Base Station)

In the present disclosure, an IAB node has functionalities of a base station. The terms “Base Station (BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, and “component carrier” may be used interchangeably. The base station may be referred to as a macro cell, a small cell, a femtocell, a pico cell or the like.

The base station can accommodate one or more (for example, three) cells. If the base station accommodates a plurality of cells, the entire coverage area of the base station can be divided into a plurality of smaller areas, and each of the smaller areas can provide a communication service based on a base station subsystem (for example, a remote radio head (RRH) serving as an indoor small base station). The term “cell” or “sector” denotes a part or all of the coverage area of at least one of the base station and the base station subsystem that perform a communication service in the coverage.

### Terminal

In the present disclosure, the terms “Mobile Station (MS)”, “user terminal”, “User Equipment (UE)”, “terminal” and the like may be used interchangeably.

The mobile station may be referred to by those skilled in the art as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terminologies.

### Base Station/Mobile Station

At least one of a base station and a mobile station may be referred to as a transmitter, a receiver, a communication apparatus, or the like. Note that at least one of the base station and the mobile station may be a device mounted in a mobility, the mobility itself, or the like. The mobility may be a vehicle (e.g., an automobile or an airplane), an unmanned mobile entity (e.g., a drone or an autonomous vehicle), or a robot (a manned-type or unmanned-type robot). Note that at least one of the base station and the mobile station may also include an apparatus that does not necessarily move during communication operation. For example, at least one of the base station and the mobile station may be an Internet-of-Things (IoT) equipment such as a sensor.

Also, the base station in the present disclosure may be interchanged with the user terminal. For example, the aspects and the embodiments of the present disclosure may be applied to an arrangement where communications between the base station and the user terminal is replaced with communications between multiple mobile stations (for example, such communication may be referred to as device-to-device (D2D), vehicle-to-everything (V2X), or the like). In this case, the mobile station may be configured to have the same functionalities as those of the above-stated IAB node. Also, the wordings “uplink” and “downlink” may be replaced with corresponding wordings for inter-terminal communication (for example, “side”). For example, an uplink channel, a downlink channel, and the like may be replaced with a side channel.

Similarly, a mobile station in the present disclosure may be replaced with a base station. In this case, the base station is configured to have the same functionalities as those of the mobile station.

### Meaning and Interpretation of Terminologies

As used herein, the term “determining” may encompass a wide variety of actions. For example, “determining” may be regarded as judging, calculating, computing, processing, deriving, investigating, looking up, searching (or, search or inquiry) (e.g., looking up in a table, a database or another data structure), ascertaining and the like. Furthermore, “determining” may be regarded as receiving (for example, receiving information), transmitting (for example, transmitting information), inputting, outputting, accessing (for example, accessing data in a memory) and the like. Also, “determining” may be regarded as resolving, selecting, choosing, establishing, comparing and the like. That is, “determining” may be regarded as a certain type of action related to determining. Also, “determining” may be replaced with “assuming”, “expecting”, “considering”, and the like.

The terms “connected” and “coupled” as well as any derivatives of the terms mean any direct or indirect connection and coupling between two or more elements, and the terms can include cases in which one or more intermediate elements exist between two “connected” or “coupled” elements. The coupling or the connection between elements may be a physical or logical coupling or connection or may be a combination of the physical and logical couplings or connections. For example, “connected” may be replaced with “accessed.” When the terms are used in the present disclosure, two elements can be considered to be “connected” or “coupled” to each other using at least one of one or more electrical wires, cables, and printed electrical connections or using electromagnetic energy with a wavelength of a radio frequency domain, a microwave domain, an optical (both visible and invisible) domain, or the like that are non-limiting and non-inclusive examples.

### Reference Signal

A reference signal can also be abbreviated as an RS and may also be referred to as a pilot depending on the applied standard.

### Meaning of “Based On”

The recitation “based on” used in the present disclosure does not mean “based only on”, unless otherwise specified. In other words, the recitation “based on” means both of “based only on” and “based at least on”.

### “First” and “Second”

Any reference to elements by using the terms “first”, “second”, and the like that are used in the present disclosure does not generally limit the quantities of or the order of these elements. These terms can be used in the present disclosure as a convenient manner of distinguishing between two or more elements. Therefore, reference to first and second elements does not mean that only the two elements can be employed, or that the first element has to precede the second element somehow.

### Means

The “unit” or “section” in the arrangements of the above respective apparatuses may be replaced with “means”, “circuitry”, “device”, or the like.

### Open Style

In cases where terms “include”, “including”, and their derivatives are used in the present disclosure, these terms are intended to be inclusive like the term “comprising”. Further, the term “or” used in the present disclosure is not intended to be an exclusive OR (XOR).

### Time Unit Such as TTI, Frequency Unit Such as RB and Radio Frame Arrangement

A radio frame may be constituted by one or more frames in the time domain. The one frame or each of the plurality of frames may be referred to as a subframe in the time domain. The subframe may be further constituted by one or more slots in the time domain. The subframe may have a fixed time length (e.g., 1 ms) independent of numerology.

The numerology may be a communication parameter that is applied to at least one of transmission and reception of a certain signal or channel. For example, the numerology may indicate at least one of SubCarrier Spacing (SCS), a bandwidth, a symbol length, a cyclic prefix length, a Transmission Time Interval (TTI), the number of symbols per TTI, a radio frame arrangement, a specific filtering processing that is performed by a transceiver in the frequency domain, a specific windowing processing that is performed by the transceiver in the time domain, and the like.

The slot may be constituted by one or more symbols (e.g., an Orthogonal Frequency Division Multiplexing (OFDM) symbol, a Single Carrier-Frequency Division Multiple Access (SC-FDMA) symbol, or the like) in the time domain. The slot may also be a time unit based on the numerology.

The slot may include a plurality of mini-slots. Each of the mini-slots may be constituted by one or more symbols in the time domain. Furthermore, the mini-slot may be referred to as a subslot. The mini-slot may be constituted by a smaller number of symbols than the slot. A PDSCH (or a PUSCH) that is transmitted in the time unit longer than the mini-slot may be referred to as a PDSCH (or a PUSCH) mapping type A. The PDSCH (or the PUSCH) that is transmitted using the mini-slot may be referred to as a PDSCH (or PUSCH) mapping type B.

The radio frame, the subframe, the slot, the mini slot, and the symbol indicate time units in transmitting signals. The radio frame, the subframe, the slot, the mini slot, and the symbol may be referred to as other corresponding names.

For example, one subframe, a plurality of continuous subframes, one slot, or one mini-slot may be referred to as a Transmission Time Interval (TTI). Namely, at least one of the subframe and the TTI may be a subframe (1 ms) in the existing LTE or have a duration (for example, 1 to 13 symbols) shorter than 1 ms or a duration longer than 1 ms. Note that a unit that represents the TTI may be referred to as a slot, a mini-slot, or the like instead of a subframe.

Here, the TTI, for example, refers to a minimum time unit for scheduling in radio communication. For example, in an LTE system, an IAB node performs scheduling for allocating a radio resource (a frequency bandwidth, transmit power, and the like that are available to each user terminal) on the unit of TTI to each user terminal. Note that the definition of TTI is not limited to this.

The TTI may be a time unit for transmitting a channel-coded data packet (a transport block), a code block, or a codeword, or may be a unit for processing such as scheduling and link adaptation. Note that, when the TTI is assigned, a time section (for example, the number of symbols) to which the transport block, the code block, the codeword, or the like is actually mapped may be shorter than the TTI.

Note that, in the case where one slot or one mini-slot is referred to as the TTI, one or more TTIs (that is, one or more slots, or one or more mini-slots) may be a minimum time unit for the scheduling. Furthermore, the number of slots (the number of mini-slots) that compose the minimum time unit for the scheduling may be controlled.

A TTI having a time length of 1 ms may be referred to as a regular TTI (a TTI in LTE Rel. 8 to LTE Rel. 12), a normal TTI, a long TTI, a regular subframe, a normal subframe, a long subframe, a slot, or the like. A TTI shorter than the regular TTI may be referred to as a shortened TTI, a short TTI, a partial TTI (or a fractional TTI), a shortened subframe, a short subframe, a mini-slot, a subslot, a slot, or the like.

Note that the long TTI (for example, the regular TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be identical regardless of the numerology, and may be 12, for example. The number of subcarriers that are included in the RB may be determined based on the numerology.

In addition, the RB may include one or more symbols in the time domain, and may have a length of one slot, one mini slot, one subframe, or one TTI. One TTI and one subframe may be constituted by one or more resource blocks.

Note that one or more RBs may be referred to as a Physical Resource Block (PRB), a Sub-Carrier Group (SCG), a Resource Element Group (REG), a PRB pair, an RB pair, or the like.

In addition, the resource block may be constituted by one or more Resource Elements (REs). For example, one RE may be a radio resource region of one subcarrier and one symbol.

A bandwidth part (BWP) (which may be referred to as a partial bandwidth or the like) may represent a subset of contiguous common resource blocks (RB) for certain numerology in a certain carrier. Here, the common RBs may be identified by RB indices that use a common reference point of the carrier as a reference. The PRB may be defined by a certain BWP and may be numbered within the BWP.

The BWP may include a UL BWP and a DL BWP. A terminal may be configured with one or more BWPs within one carrier.

At least one of the configured BWPs may be active, and the terminal does not have to assume transmission/reception of a predetermined signal or channel outside the active BWP. Note that “cell”, “carrier”, and the like in the present disclosure may be replaced with “BWP”.

Structures of the radio frame, the subframe, the slot, the mini-slot, the symbol, and the like as described above are merely illustrative. For example, the arrangement such as the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be changed in various ways.

In cases where articles, such as “a”, “an”, and “the” in English, for example, are added in the present disclosure by translation, nouns following these articles may have the same meaning as used in the plural.

The expression “A differs from B” may mean “A mutually differs from B” in the present disclosure. Note that the expression may mean “A and B each differs from C.” The terminologies “separate”, “couple” or the like may be interpreted similar to “differ”.

### Variations and the Like of Aspects

The aspects and embodiments described in the present disclosure may be independently used, may be used in combination, or may be switched and used along the execution. Furthermore, notification of predetermined information (for example, notification indicating “it is X”) is not limited to explicit notification, and may be performed implicitly (for example, by not notifying the predetermined information).

While the present disclosure has been described in detail, it is obvious to those skilled in the art that the present disclosure is not limited to the embodiments described in the present disclosure. Modifications and variations of the aspects of the present disclosure can be made without departing from the spirit and the scope of the present disclosure defined by the description of the appended claims. Therefore, the description of the present disclosure is intended for exemplary description and does not limit the present disclosure in any sense.

### REFERENCE SYMBOL LIST

10: Radio communication system
100: Base station (gNB)
200: Terminal (UE)

1. A terminal, comprising:
a control unit that determines a Modulation and Coding Scheme (MCS) and a number of repetitions from an MCS field in an uplink grant for repetitive transmissions of an uplink data channel for retransmission in a random access procedure; and
a transmission unit that repeatedly transmits the uplink data channel for retransmission in the random access procedure in accordance with the MCS and the number of repetitions.

2. The terminal as claimed in claim 1, wherein the control unit determines a number of bits indicative of the MCS or a number of bits indicative of the number of repetitions in the MCS field based on system information.

3. The terminal as claimed in claim 1 or 2, wherein the control unit determines the MCS for repetitive transmission of the uplink data channel for retransmission based on MCS mapping information used for initial transmission.

4. The terminal as claimed in any one of claims 1 to 3, wherein the control unit determines MCS mapping information based on a predetermined rule or system information.

5. A base station, comprising:
a control unit that configures a Modulation and Coding Scheme (MCS) and a number of repetitions in an MCS field of an uplink grant for repetitive transmissions of an uplink data channel for retransmission in a random access procedure; and
a reception unit that repeatedly receives the uplink data channel for retransmission in the random access procedure in accordance with the MCS and the number of repetitions.

6. A radio communication method implemented by a terminal, comprising:
determining a Modulation and Coding Scheme (MCS) and a number of repetitions from an MCS field in an uplink grant for repetitive transmissions of an uplink data channel for retransmission in a random access procedure; and
repeatedly transmitting the uplink data channel for retransmission in the random access procedure in accordance with the MCS and the number of repetitions.
